(19) United States
(12) Patent Application Publication
(10) Pub. No.: US 2013/0014610 A1
(43) Pub. Date: Jan. 17, 2013

(54) STARTING DEVICE

(71) Applicants: Javier Bores, Vaihingen-Kleinglattbach (DE); Sven Hartmann, Stuttgart (DE); Verena Frueh, Stuttgart (DE)

(72) Inventors: Javier Bores, Vaihingen-Kleinglattbach (DE); Sven Hartmann, Stuttgart (DE); Verena Frueh, Stuttgart (DE)

(73) Assignee: ROBERT BOSCH GMBH, Stuttgart (DE)

(21) Appl. No.: 13/520,299

(22) PCT Filed: Nov. 26, 2010
(86) PCT No.: PCT/EP10/68282

§ 371 Date: Oct. 1, 2012

(30) Foreign Application Priority Data
Dec. 30, 2009 (DE) 10 2009 055 414.9

(51) Int. Cl. F02N 15/02

(52) U.S. Cl. 74/7 E

(57) ABSTRACT

The invention relates to a starting device (22) for internal combustion engines (10). The starting device (22) comprises an electric drive (28) for a drive pinion (24). A gearwheel (16) is mounted on the crankshaft (12) of the internal combustion engine (10). An engaged state of the drive pinion (24) on a drive shaft (26) of the electric drive (28) is effected either by a spacer piece (40) or the starting device (22) is arranged with a reduced spacing (54) in relation to the gearwheel (16).

### BACKGROUND OF THE INVENTION

Drives, which are supplied by an energy source separate from the fuel supply, are used to start internal combustion engines. Primarily direct current motors are used for this purpose, the drive pinion of which engages with the ring gear of the internal combustion engine in order then to turn over said internal combustion engine. This starting procedure occurs by means of the starter according to the screw-push principle. Upon completion of startup, the pinion disengages again from the ring gear of said internal combustion engine.

The increasing use of start-stop systems in motor vehicles requires an expanded demand on the starting system and thereby also an expansion of the functionality of starters used to date. More stringent acoustic requirements are, e.g., to be mentioned in this regard as well as the need for the engine to be able to start again when a starting request of the driver is signaled (“change of mind function”). Especially when the internal combustion engine is coming to a stop, this restarting of the engine is not possible using the classic principle of starters used to date.

By means of a suitable actuation of the engaging mechanism and the electrical drive of the starter, said starter can be put into the position of engaging with the ring gear even when the internal combustion engine is coming to a stop. The aforementioned functionality is thereby fulfilled.

A starting device for starting an internal combustion engine is known from the German patent publication DE 197 21 386 A1 and the European Parliament patent publication EP 0 848 159 B1. According to this solution, the starting device comprises a starter motor which can be connected to a voltage source via a starter relay and can be brought into engagement with the internal combustion engine for the purpose of cranking said engine. An actuation of the starter relay and/or the starter motor takes place via an electronic control device. Said control device controls the semiconductor power output stages associated with the starter relay and/or the starter motor such that at least in a start-stop operation of the internal combustion engine, the starter relay is in the engagement position thereof in the stopped state of said internal combustion engine.

A starter having permanent engagement for an internal combustion engine is known from the German patent publication DE 10 2007 029 353 A1. The starter comprises a hollow wheel which is constantly engaged with a pinion gear that is connected to an electric motor. A flywheel comprises a freewheel clutch, which is designed such that the torque, which is produced by the electric motor, is transmitted from the hollow wheel to the flywheel in order to start the internal combustion engine. A moment of inertia M1, which is required to rotate the crankshaft of the internal combustion engine after a startup of said engine, a moment of inertia M2 of the flywheel, a resulting moment of inertia M3 of the hollow wheel and the flywheel as well as a resulting moment of inertia M4 of a hollow wheel and a flywheel of a sub-starter are selected such that a startup of the internal combustion engine occurs only during engagement of the hollow wheel with the flywheel and a relation M1<M2<M4<M3 is fulfilled. This ensures the stability when cranking the engine.

The German patent publication DE 10 2004 044 932 A1 relates to a starting device. An axial movement of a pinion gear and an output shaft and a looseness in a rotation direction of said pinion gear with respect to the output shaft are prevented, and therefore wear to a gear shaft connecting section between said pinion gear and the output shaft and wear to said pinion gear and to a hollow wheel are reduced. In so doing, the tooth engagement noise, which is produced when starting the engine, is reduced. The starting device comprises an output shaft as well as a thrust receiving face with which the axial end face of an inner ring of a bearing is brought into contact. The starting device further comprises a threaded section formed on the end of the output shaft. The pinion gear is arranged such that the end face thereof on the bearing side is brought into contact with the end face of the inner ring of the bearing on the pinion shaft. Said pinion gear is pressed in the direction of said bearing by the fastening force of a screw which is situated on the threaded section. Said pinion gear, said output shaft and said bearing are mounted such that the thrust receiving face and the end face on the bearing side of said pinion gear clamp the inner ring of said bearing.

### SUMMARY OF THE INVENTION

Pursuant to the solution proposed according to the invention, the starting actuator remains permanently in engagement with a ring gear in order to implement the Mind Change functionality, wherein the ring gear can be coupled to or uncoupled from the crankshaft of the internal combustion engine via a freewheel clutch. In a first embodiment variant of the solution proposed according to the invention, a ring gear is mounted on the crankshaft of the internal combustion engine. The ring gear can be moved relative to the crankshaft; thus enabling said ring gear to be at rest while the internal combustion engine is running. This enables a drive pinion of the starting device to be held permanently in engagement with the gearing of the ring gear in order to perform an engine startup at any time without having to wait until said internal combustion engine comes to a stop and only then to mesh the drive pinion with said ring gear.

The first embodiment mentioned above of the thought underlying the invention has however the disadvantage that fundamental interventions into the drive train of a vehicle are required. The first embodiment variant mentioned above can thus initially be used only for small quantities. Because today starting devices serially produced in large quantities have achieved a high degree of standardization, the adaptation mentioned above, i.e. the omission of the freewheel as well as the engaging mechanism for a small number of items does not usually represent a cost advantage but means additional complexity, which inevitably would be reflected in the production costs.

Based on standard conventional screw-push starting devices for internal combustion engines, it is proposed in execution of the thought underlying the invention to perform the least possible modifications to the standard screw-push starting devices used to date, thus, for example, Bosch R-Starter, ISBN 3-7782-20284, yellow series, Bosch Kraftfahrzeugtechnik (Bosch Automotive Technology), 2002, pages 76-79. In so doing, cost advantages can be made use of with regard to large quantities. This means that the omission of the standardly designed engaging apparatus used up until now and the omission of the freewheel functionality are not consciously implemented.

In the second embodiment variant of the solution proposed according to the invention, a standardized starting device while retaining the freewheel and the engaging mechanism is modified such that the rest position of the drive pinion of the starting device is displaced by means of a spacer piece in such a way that said drive pinion is situated permanently in engagement with the ring gear of the internal combustion engine, which is disposed on the crankshaft.

The engaging mechanism comprises as before an engaging relay, which however includes an altered rest position and a reduced engagement travel. This results in a reduction of the noise emission as well as a reduced contact bounce on account of a reduced maximum speed being achieved during engagement. The relay winding can be selected according to required specifications.

As an alternative thereto, the starting device, in particular the drive pinion disposed on the output shaft of the electric drive, is disposed so as to be displaced closer to the ring gear of the internal combustion engine in a further embodiment variant to the thought underlying the invention. In so doing, it can on the one hand be achieved that the output pinion is held permanently engaged with the ring gear of the internal combustion engine and on the other hand, installation space can be saved. When using this solution, the free travel of the engaging mechanism is enlarged. It is also conceivable to remove the fork lever used up until now on said engaging mechanism and to provide a separate spacing stop on the engaging relay.

### BRIEF DESCRIPTION OF THE DRAWINGS

The invention is described below in more detail with the aid of the drawings.

In the drawings:

FIG. 1 shows a first embodiment of the starting device proposed according to the invention having a pinion rest position, which makes a permanent engagement of the drive pinion and the ring gear possible by use of a spacer piece,

FIG. 1.1 shows a detail drawing for the construction of the fork lever and

FIG. 2 shows a further embodiment variant of the starting device proposed according to the invention having a permanent engagement between the drive pinion and the ring gear by means of a shift in position of the starter with respect to the ring gear.

### DETAILED DESCRIPTION

In the following embodiments with regard to the invention, a standard starting device is discussed in connection with the starting device 22. Said standard starting device thereby relates to a standard screw-push starter, as is, e.g., described in the publication Bosch R-Starter, ISBN 3-7782-20284, yellow series, Kraftfahrzeugtechnik (Automotive Technology), 2002, pages 76 to 79.

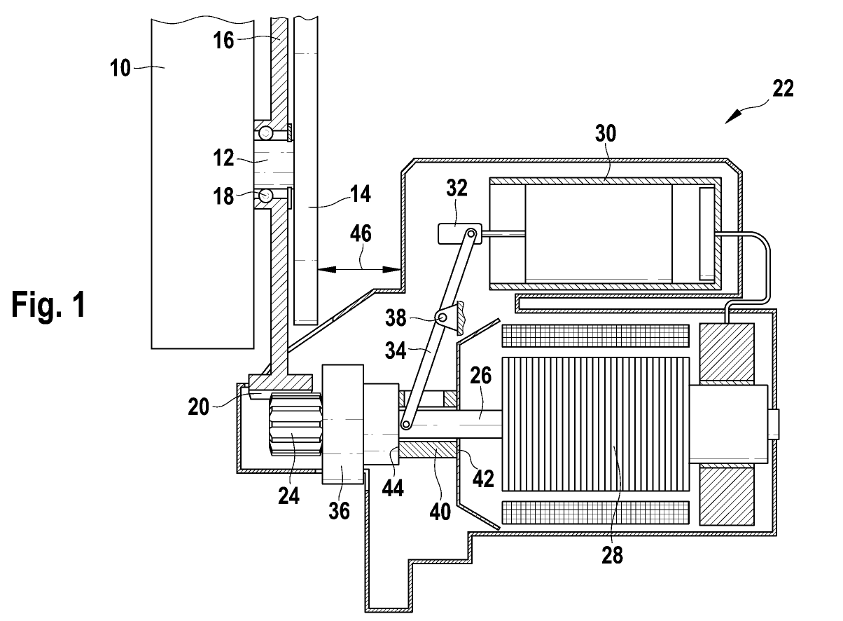

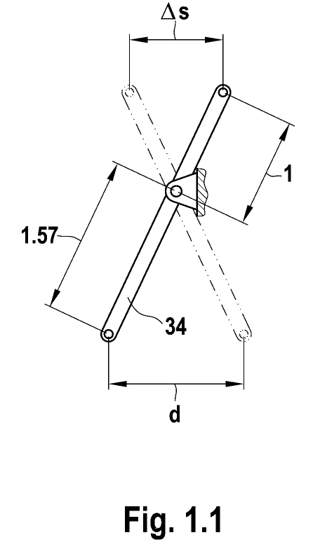

A first embodiment variant of a starting device proposed according to the invention is to be seen in the depiction according to FIG. 1, in which the drive pinion is situated in permanent engagement with a gearwheel of an internal combustion engine, in particular with a gearwheel on the crankshaft of the internal combustion engine.

FIG. 1 shows an internal combustion engine 10 comprising a crankshaft 12. A gearwheel, in particular a ring gear 16, is received on the crankshaft 12 in addition to a flywheel 14, which can relate to a single-mass or multi-mass flywheel. A relative movement between this gearwheel 16 and the crankshaft 12 is thereby possible by virtue of the fact that said gearwheel 16, in particular configured as a ring gear, is received on a freewheel 18. The possibility thereby exists for the gearwheel, in particular configured as a ring gear 16, to rotate with another circumferential speed than the crankshaft 12.

As can be seen in the depiction according to FIG. 1, the gearing 20 of the gearwheel 16 meshes with a drive pinion 24 of a starting device 22. In the embodiment depicted in FIG. 1 and proposed according to the invention, the starting device 22 is disposed at a first distance 46 with respect to said gearwheel 16.

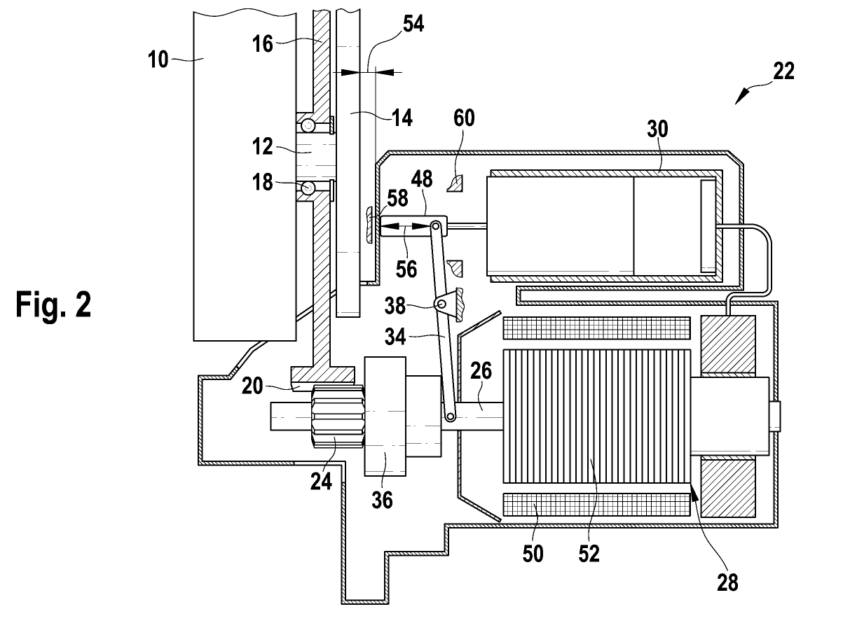

The starting device 22, which is depicted in FIG. 1 and is proposed according to the invention, relates to a standard starting device, a screw-push starter, Bosch R-Starter, ISBN 3-7782-20284, yellow series, Kraftfahrzeugtechnik (Automotive Technology), “Starters and Generators”, 2002, pages 76 to 79, and reduction-gear starters R70, which have an electric drive 28 that is particularly designed as a DC drive. The electric drive comprises a stator 50 and a rotor 52, cf. depiction pursuant to FIG. 2. In addition, the starting device comprises an engaging relay 30 which acts on a fork lever 34. The fork lever 34 can be pivoted about a pivot point 38. Corresponding to the retraction or respectively extension travel of the engaging relay 30, an axial displacement of the drive pinion 24, which is associated with a freewheel, is produced when actuating the fork lever 34 along a connecting link 32.

It is apparent from the first embodiment variant of the solution proposed according to the invention, which is depicted in connection with FIG. 1, that in order to implement a permanent engagement, a spacer piece 40 is disposed between the gearwheel 16 on the crankshaft 12, mounted in the freewheel 18, and the drive pinion 24 of the starting device 22 and the freewheel 36 thereof. The spacer piece 40 is designed in a sleeve-shaped fashion in the embodiment of the solution proposed according to the invention, which is depicted in FIG. 1, and comprises a first end face 42 as well as a second end face 44. Whereas the first end face 42 faces the electric drive 42, the second end face 44 of the spacer piece 40, which is designed in the form of a sleeve, supports a collar of the freewheel 36, which is associated with the drive pinion 24. The provision of said spacer piece 40 makes it possible for the drive pinion 24 and the gearwheel 16 to always be held in engagement, i.e. in the engaged state. The position depicted in FIG. 1 represents the rest position of the drive pinion 24, in which said pinion meshes with the gearing 20 of the gearwheel 16. In accordance with the first embodiment variant, the engaging relay 30 of the starting device 22 has an altered rest position and a reduced retraction travel. Reference is made to FIG. 1.1 in that regard. The relay travel, which the relay 30 carries out, is shortened by)s=d/1.75. The length of the spacer piece 40 is thereby designated with d. The transmission of force by the fork lever 34, i.e. the lever travel, is 1.57. The relay 30 thereby has a different rest position which is exactly offset by)s=d/1.57.

A reduction of the refraction travel by )s makes a reduction in the noise emission and a reduced contact bounce possible, and therefore the noise level is considerably reduced during actuation of the starting device 22 in the first embodiment variant thereof. The winding of the engaging relay 30 can be designed relatively weak within the framework of the modular design principle, so that the current consumption is limited.

The starting device 22 described above in connection with FIG. 1 is characterized in that in comparison to a standard starting device, Bosch R-Starter, ISBN 3-7782-20284, yellow series, Kraftfahrzeugtechnik (Automotive Technology), “Starters and Generators”, 2002, pages 76 to 79, reduction-gear starters with only the slightest modification requirements are to be provided at said starting device. Only a spacer piece 40 is required in order to achieve a permanent engagement between the gearing 20 of the gearwheel 16 and the drive pinion 24 of the starting device 22. The Mind-Change functionality can also thereby be achieved with a starting device that is today in standard use.

A further alternative embodiment variant for implementing a permanent engagement between the gearwheel 16 on the crankshaft of the internal combustion engine and the drive pinion of the starting device can be seen in the depiction pursuant to FIG. 2.

In contrast to the embodiment variant depicted in FIG. 1, the starting device 22 pursuant to the depiction in FIG. 2 is arranged with a, with regard to the gearwheel 16 on the crankshaft 12, reduced second spacing 54; and therefore at an identical axial position of the drive pinion 24 including the freewheel 36 on the drive shaft 26, there is a displacement of the starting device 22 closer to the internal combustion engine 10 in comparison to a standard starter, screw-push starter, Bosch R-Starter, ISBN 3-7782-20284, yellow series, Kraftfahrzeugtechnik (Automotive Technology), “Starters and Generators”, 2002, pages 76 to 79, cf. there reduction-gear starters R70. A permanent engagement between the gearing 20 of the gearwheel 16 and the gearing of the drive pinion 24 of the drive shaft 26 can thereby be implemented in a simple manner. The engaging relay 30 of the second embodiment variant of the modified standard starting device proposed according to the invention, which is depicted in FIG. 2, is, cf. position 56, designed having an enlarged free travel. Instead of the fork lever 34 (cf. FIG. 2), which is depicted in the second embodiment variant of the solution proposed according to the invention and which can be moved about the pivot point 38, a spacing stop is also conceivable. The spacing stop 58 can be disposed such that said stop is located directly opposite to an extended connecting link 48. Instead of the spacing stop 58, a separate stop 60 can also be provided, as is indicated in the depiction pursuant to FIG. 2. The engaging relay 30 performs a switching operation. Said relay has to switch the starter current when it is completely drawn in. An engaging relay 30 in standard use has this travel, which must continue to be facilitated in the new installation position in order to switch the starter current.

It can be ensured by means of the freewheels 18 and 36 on the gearwheel 16, especially designed as a ring gear, and on the drive pinion 24 that a torque is transmitted only in one rotational direction of the electric drive 28, said torque serving to start the internal combustion engine from engine standstill.

Because the permanent engagement between the gearwheel 16 and the drive pinion 24 of the starting device 22 is ensured in both embodiment variants, the internal combustion engine 10 does not have to come to a standstill before said drive pinion 24 can be engaged by means of the engaging relay 30 with the gearing 20 of the gearwheel 16. The engaging relay 30 takes over the switching of the starter current.

1. A starting device (22) for an internal combustion engine (10), wherein the starting device (22) comprises an electric drive (28) for a drive pinion (24) and a gearwheel (16) configured to be mounted on a crankshaft (12) of the internal combustion engine (10), characterized in that the drive pinion (24) is transferred into an engaged state either by means of a spacer piece (40) on a drive shaft (26) of the electric drive (28) or the starting device (22) is arranged with a reduced spacing (54) in relation to the gearwheel (16).

2. The starting device (22) according to claim 1, characterized in that the spacer piece (40) is in the shape of a sleeve.

3. The starting device (22) according to claim 1, characterized in that the spacer piece (40) is disposed on the drive shaft (26) between the electric drive (28) and a freewheel (30) of the drive pinion (24).

4. The starting device (22) according to claim 2, characterized in that said starting device is arranged with a reduced, second spacing (54) in relation to the gearwheel (16) with regard to a first spacing with which a standard starting device is spaced apart from said gearwheel (16).

5. The starting device (22) according to claim 1, characterized in that an engaging relay (30) comprises an enlarged free travel (56) as well as a spacing stop (58).

6. The starting device (22) according to claim 5, characterized in that the spacing stop (58) is located opposite to an extended connecting link (48).

7. The starting device (22) according to claim 1, characterized in that an engaging relay (30) acts on a fork lever (34), which is pivotable about a pivot point (38) and which axially moves the drive pinion (24) and a freewheel (36) thereof on the drive shaft (26), and said engaging relay switches a starter current.

8. The starting device (22) according to claim 1, characterized in that the drive shaft (26) is a multiple splined shaft, a shaft.

9. The starting device (22) according to claim 1, characterized in that the drive shaft (26) is a shaft with a polygonal profile.

10. The starting device (22) according to claim 1, characterized in that the drive shaft (26) has at least one feather key.
